(19) United States
(12) Patent Application Publication
(10) Pub. No.: US 2010/0009231 A1
(43) Pub. Date: Jan. 14, 2010

(54) STACK AND FUEL CELL POWER GENERATION SYSTEM HAVING THE SAME

(75) Inventors: Sung-Han KIM, Seoul (KR); Jae-Hyuk Jang, Seoul (KR); Craig Matthew Miesse, Seoul (KR); Hye-Yeon Cha, Yongin-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/427,230

(22) Filed: Apr. 21, 2009

(30) Foreign Application Priority Data
Jul. 9, 2008 (KR) 10-2008-0066352

(51) Int. Cl. H01M 8/10

(52) U.S. Cl. 429/30

(57) ABSTRACT

A stack and a fuel cell power generation system equipped with the stack are disclosed. In accordance with an embodiment of the present invention, the stack, which generates electrical energy by reacting hydrogen with oxygen and in which the hydrogen is supplied as a fuel and the oxygen is in the air, includes: a membrane electrode assembly (MEA), which includes an electrolyte membrane and a pair of electrodes coupled to either surface of the electrolyte membrane; and a pair of current collectors, which is formed on either surface of the membrane electrode assembly, in which the current collector includes: an insulating polymer film; and a conductive adhesive layer, which is interposed between the insulating polymer film and the membrane electrode assembly.

### CROSS-REFERENCE TO RELATED APPLICATIONS

This application claims the benefit of Korean Patent Application No. 10-2008-0066352, filed with the Korean Intellectual Property Office on Jul. 9, 2008, the disclosure of which is incorporated herein by reference in its entirety.

### BACKGROUND

1. Technical Field

The present invention relates to a stack and a fuel cell power generation system having the same.

2. Description of the Related Art

The fuel cell power generation system is a system for generating electricity by electrochemically reacting a hydrogen-containing fuel, such as methanol, etc., with an oxidizing gas, such as air, etc. The fuel cell power generation system is regarded as a clean energy source for satisfying the increasing demand for power consumption while providing a solution to environmental problems resulting from the use of fossil energy.

The fuel cell power generation system generally includes a fuel cell stack, in which a multiple number of unit cells for generating electricity are stacked over one another. The basic structure of the stack includes multiple unit cells stacked between end plates and fastened together with bolts and nuts. A unit cell may be composed of a membrane electrode assembly (MEA) having a fuel electrode and an air electrode attached to either side of an electrolyte membrane and separators, i.e., bipolar plates, which are positioned on either side of the membrane electrode assembly and in which fluid channels are formed.

The bipolar plate operates to supply the hydrogen-containing fuel and oxygen to the fuel electrode and air electrode, respectively, and discharge the carbon dioxide and water generated at the fuel electrode and air electrode, respectively, to the outside.

Here, current collectors are provided, for collecting the electricity generated by the membrane electrode assembly, between the bipolar plates positioned at the outermost ends of the group of unit cells (hereinafter referred to as “outermost bipolar plates”) and the end plates. A current collector not only collects the electricity but also provides reinforcement against the brittleness of the outermost bipolar plates when fastening the bolts and nuts.

Recently, a flexible type of the current collector has been used. In this case, the flexible type may be more easily deformed than a rigid type, causing a problem of reliability in the attachment of the stacking structure of the stack.

### SUMMARY

The present invention provides a reliable stack and a fuel cell power generation system equipped with the stack by forming a firmly stacking structure using a current collector having an adhesive layer.

An aspect of the present invention provides a stack. In accordance with an embodiment of the present invention, the stack, which generates electrical energy by reacting hydrogen with oxygen and in which the hydrogen is supplied as a fuel and the oxygen is in the air, includes: a membrane electrode assembly (MEA), which includes an electrolyte membrane and a pair of electrodes coupled to either surface of the electrolyte membrane; and a pair of current collectors, which is formed on either surface of the membrane electrode assembly, in which the current collector includes: an insulating polymer film; and a conductive adhesive layer, which is interposed between the insulating polymer film and the membrane electrode assembly.

The conductive adhesive layer can include an adhesive epoxy and at least one of metal powder and metal wire. The polymer film can be made of a flexible material.

The current collector can further include a metal pad, which is interposed between the polymer film and the conductive adhesive layer, and the metal pad can be made of a material comprising gold (Au).

The electrode can be constituted by a plurality of unit electrodes, and the metal pad can be constituted by a plurality of unit pads in accordance with a shape of the unit electrode. Each of the unit pads can have a terminal formed thereon, in which the terminal is protruded outward from the current collector.

The current collector can include a plurality of apertures formed thereon, and a pair of end plates can be formed on the outside of the current collector.

The end plate of a side from which the fuel is supplied has a slit formed thereon in a shape of serpentine, and an aperture of the current collector of a side to which the fuel is supplied can be shaped to correspond to the slit.

The end plate of a side to which the air is supplied can have a hole for air flow formed thereon, and an aperture of the current collector of a side to which the air is supplied can be shaped to correspond to the hole. The hole can be rectangular and occupy 65% of the total area of the electrode.

The stack can further include a gasket, which is interposed between the current collector and the membrane electrode assembly and seals a gap between the current collector and the membrane electrode assembly.

Another aspect of the present invention provides a fuel cell power generation system. The fuel cell power generation system in accordance with an embodiment of the present invention includes: a fuel cell stack, which generates electrical energy by reacting hydrogen with oxygen and in which the hydrogen is supplied as fuel and the oxygen is in the air; a fuel supplying unit, which supplies a fuel to the fuel cell stack and in which the fuel contains hydrogen; and an air supplying unit, which supplies air to the fuel cell stack, in which the fuel cell stack includes: a membrane electrode assembly (MEA), which includes an electrolyte membrane and a pair of electrodes coupled to either surface of the electrolyte membrane; and a pair of current collectors, formed on either surface of the membrane electrode assembly, and in which the current collector includes: an insulating polymer film; and a conductive adhesive layer, which is interposed between the polymer film and the membrane electrode assembly.

The conductive adhesive layer can include an adhesive epoxy and at least one of metal powder and metal wire. The polymer film can be made of a flexible material.

The current collector can further include a metal pad, which is interposed between the polymer film and the conductive adhesive layer, and the metal pad can be made of a material comprising gold (Au).

The electrode can be constituted by a plurality of unit electrodes, and the metal pad can be constituted by a plurality of unit pads in accordance with a shape of the unit electrode. Each of the unit pads can have a terminal formed thereon, in which the terminal is protruded outward from the current collector.

The current collector can include a plurality of apertures formed thereon, and a pair of end plates can be formed on the outside of the current collector.

The end plate of a side from which the fuel is supplied has a slit formed thereon in a shape of serpentine, and an aperture of the current collector of a side to which the fuel is supplied can be shaped to correspond to the slit.

The end plate of a side to which the air is supplied can have a hole for air flow formed thereon, and an aperture of the current collector of a side to which the air is supplied can be shaped to correspond to the hole. The hole can be rectangular and occupy 65% of the total area of the electrode.

The fuel cell power generation system can further include a gasket, which is interposed between the current collector and the membrane electrode assembly and seals a gap between the current collector and the membrane electrode assembly.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded view illustrating an embodiment of a stacking structure of a stack according to an aspect of the present invention.

FIG. 2 is a plan view illustrating a membrane electrode assembly of an embodiment of a stack according to an aspect of the present invention.

FIG. 3 is a side view illustrating a membrane electrode assembly of an embodiment of a stack according to an aspect of the present invention.

FIG. 4 is a plan view illustrating a current collector adjacent to an air electrode of an embodiment of a stack according to an aspect of the present invention.

FIG. 5 is a side view illustrating a current collector adjacent to an air electrode of an embodiment of a stack according to an aspect of the present invention.

FIG. 6 is a plan view illustrating a current collector adjacent to a fuel electrode of an embodiment of a stack according to an aspect of the present invention.

FIG. 7 is a plan view illustrating an end plate adjacent to an air electrode of an embodiment of a stack according to an aspect of the present invention.

FIG. 8 is a graph illustrating a stack performance based on hole shapes and opening ratios for an end plate adjacent to an air electrode of an embodiment of a stack according to an aspect of the present invention.

FIG. 9 is a plan view illustrating an end plate adjacent to a fuel electrode of an embodiment of a stack according to an aspect of the present invention.

FIG. 10 is a plan view illustrating a gasket of an embodiment of a stack according to an aspect of the present invention.

FIG. 11 is a conceptual diagram illustrating a fuel cell power generation system according to another aspect of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A stack and a fuel cell power generation system equipped with the stack according to certain embodiments of the present invention will be described below in more detail with reference to the accompanying drawings. Those components that are the same or are in correspondence are rendered the same reference numeral regardless of the figure number, and redundant explanations are omitted.

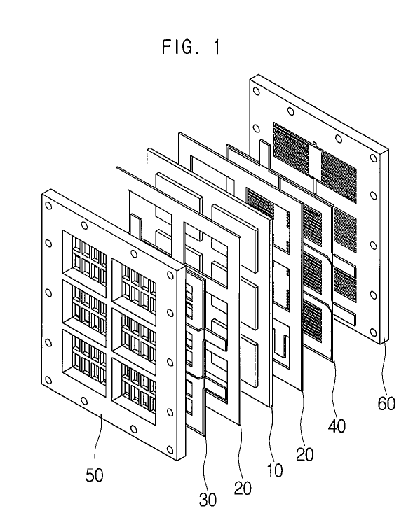

FIG. 1 is an exploded view illustrating an embodiment of a stacking structure of a stack according to an aspect of the present invention. Illustrated in FIG. 1 are a membrane electrode assembly 10 (MEA), a gasket 20, current collectors 30 and 40 and end plates 50 and 60.

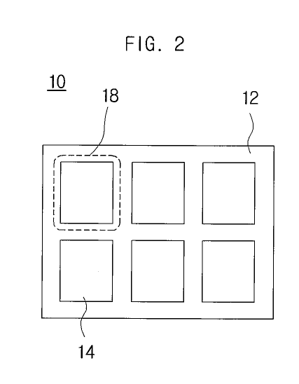

The gasket 20, the current collectors 30 and 40 and the end plates 50 and 60 are successively placed on both sides of the membrane electrode assembly 10 from the center to the outside. The membrane electrode assembly 10 is practically for generating electricity by using fuel, and the gasket 20 is for preventing the leakage of fuel and air. The current collectors 30 and 40 are for accumulating the electricity generated from the membrane electrode assembly 10. The end plates 50 and 60, which are positioned on either side of the stack 100, complete the stacking structure of the stack 100 by compressing the stack 100 from the outermost edge of the stacking structure. Detailed descriptions about each component will be described with reference to FIGS. 2 to 9.

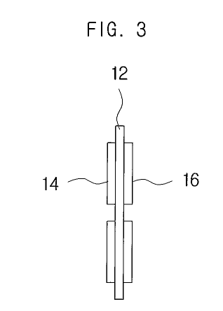

FIG. 2 is a plan view illustrating a membrane electrode assembly of an embodiment of a stack according to an aspect of the present invention, and FIG. 3 is a side view illustrating a membrane electrode assembly of an embodiment of a stack according to an aspect of the present invention. Illustrated in FIGS. 2 and 3 are an electrolyte membrane 12 and unit electrodes 14 and 16. The membrane electrode assembly 10 is virtually for generating electricity by reacting a fuel with a catalyst and constituted by an electrolyte membrane 12, which has a preferential permeability of hydrogen ions, and a pair of electrodes, i.e., a fuel electrode and an air electrode, coupled to either surface of the electrolyte membrane 12.

Hereinafter, the reactions at each electrode will be described with an example of a polymer electrolyte membrane fuel cell (PEMFC) using hydrogen as fuel.

[Reaction Scheme 1] Fuel electrode: H₂→2H⁺+2e⁻

[Reaction Scheme 2] Air electrode: (½)O₂+2H⁺+2e⁻→H₂O

[Reaction Scheme 3] Overall Reaction: H₂+(½)O₂→H₂O

Through these reactions, electricity is generated, and water is generated at the air electrode. As described above, the above reactions occur only if the polymer electrolyte membrane fuel cell (PEMFC) using hydrogen as fuel is used, and it shall be obvious that the reactions at each electrode can be varied, depending on the type of a fuel cell.

The electrode can be constituted by a fuel electrode and an air electrode, which are separated by the electrolyte membrane 12, but, as illustrated in FIG. 2, it can be constituted by a plurality of unit electrodes 14 and 16. Here, a unit cell 18, which is constituted by a unit electrode 14 of the fuel electrode, a unit electrode 16 of the air electrode and the electrolyte membrane 12, can function as an independent cell. In a flat type fuel cell stack, a potential difference of the entire fuel cell can be increased by dividing a plane of the stack into a plurality of unit cells 18 and connecting each of the plurality of unit cells 18 in series. The structure of the unit cell 18 can affect the entire structure of the stack, and thus the shape of the current collector 30 and 40, the gasket 20 and the end plates 50 and 60 can be determined in accordance with the shape of the unit cell 18, as illustrated in FIG. 1.

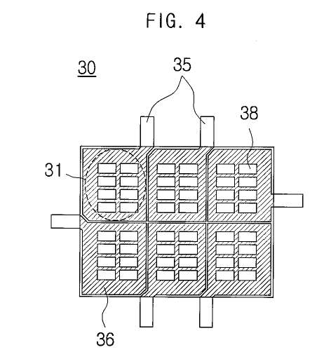

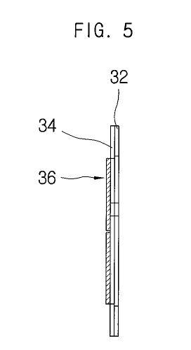

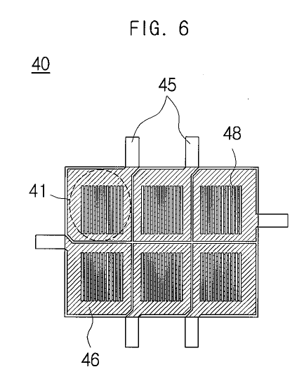

Next, FIG. 4 is a plan view illustrating a current collector adjacent to an air electrode of an embodiment of a stack according to an aspect of the present invention, and FIG. 5 is a side view illustrating a current collector adjacent to an air electrode of an embodiment of a stack according to an aspect of the present invention. Moreover, FIG. 6 is a plan view illustrating a current collector adjacent to a fuel electrode of an embodiment of a stack according to an aspect of the present invention. Illustrated in FIGS. 4 to 6 are a polymer film 32, a metal pad 34, terminals 35 and 45, a conductive adhesive layer 36 and apertures 38 and 48.

The current collectors 30 and 40 are devices that accumulate electrical energy generated from the membrane electrode assembly (10 in FIG. 1) and coupled to the fuel electrode and the air electrode of the membrane electrode assembly (10 in FIG. 1), respectively, to form a stacking structure.

As illustrated in FIG. 5, the current collectors 30 and 40 have a stacking structure, in which the metal pad 34 is coated on the insulating polymer film 32 functioning as a base layer and the conductive adhesive layer 36 is formed on the metal pad 34.

The polymer film 32 can be made of a flexible material, which is polymer resin, for example, polyimide, and has a good chemical resistance and relatively high heat resistance.

The conductive adhesive layer 36 can be formed by coating a conductive adhesive, in which an adhesive epoxy is mixed with metal powder or metal wire. The metal powder and the metal wire can be made of a material including nickel (Ni) and silver (Ag) and mixed with the epoxy in various ratios, depending on the adhesion and electrical conductivity.

Although the conductive adhesive layer 36 itself conducts electricity and functions as the current collectors 30 and 40, as illustrated in FIG. 5, the metal pad 34 having greater electrical conductivity can be formed on the insulating polymer film 32, and then the conductive adhesive layer 36 can be formed on the metal pad 34, so that more reliable current collectors 30 and 40 can be implemented.

The metal pad 34 can be formed by coating a highly electrical conductive material, for example, gold (Au). The metal pad 34 can be constituted by a plurality of unit pads 31 and 41, as illustrated in the drawings. Each of the unit pads 31 and 41 is divided by the insulating polymer film 32.

The terminals 35 and 45, which are for connecting the unit pads 31 and 41, can be protruded outward from the current collectors 30 and 40. By stacking the current collector 30 adjacent to the air electrode and the current collector 40 adjacent to the fuel electrode on the membrane electrode assembly (10 in FIG. 2) being interposed between the current collectors 30 and 40, the terminal 35 adjacent to the air electrode can face the corresponding terminal 45 adjacent to the fuel electrode. As a result, each of the adjacent unit cells (18 in FIG. 2) can be connected to each other in series.

The current collector 30 adjacent to the air electrode can have the aperture 38 formed thereon such that air can be supplied to the membrane electrode assembly (10 in FIG. 1). The size and shape of the aperture 38 can be mainly dependent on the size of a hole 58 of the end plate 50 adjacent to the air electrode, and thus this will be described later in more detail when the end plate 50 is described.

The current collector 40 adjacent to the fuel electrode can have the aperture 48 form thereon such that hydrogen as fuel can be supplied to the membrane electrode assembly (10 in FIG. 1). The size and shape of the apertures 48 can be mainly dependent on the shape of a slit 68 of the end plate 60 adjacent to the fuel electrode, and thus this will be described later in detail when the end plate 60 is described.

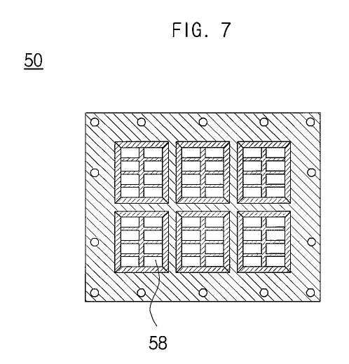

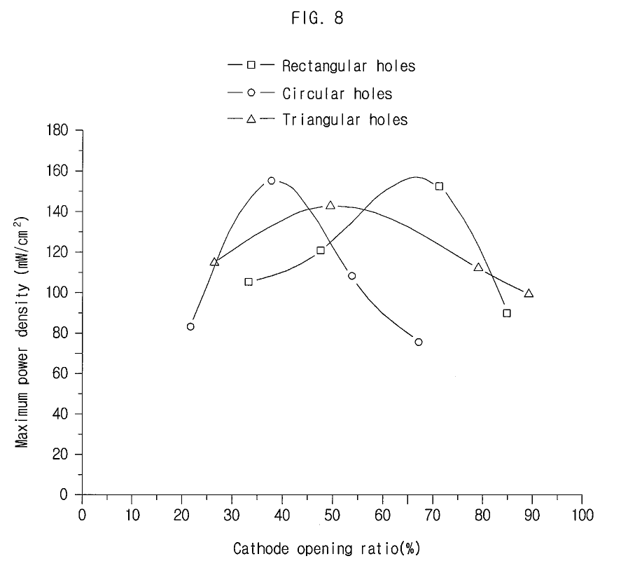

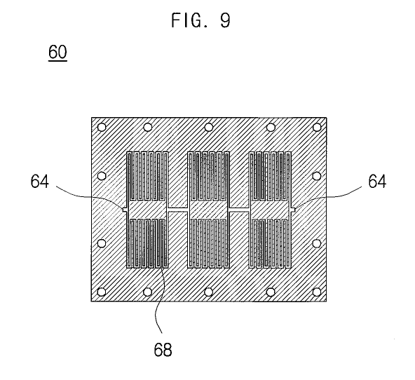

Next, referring to FIGS. 7 to 9, the end plates 50 and 60 will be described. FIG. 7 is a plan view illustrating an end plate adjacent to an air electrode of an embodiment of a stack according to an aspect of the present invention, and FIG. 8 is a graph illustrating a stack performance based on hole shapes and opening ratios for an end plate adjacent to an air electrode of an embodiment of a stack according to an aspect of the present invention. Moreover, FIG. 9 is a plan view illustrating an end plate adjacent to a fuel electrode of an embodiment of a stack according to an aspect of the present invention.

The role of the end plates 50 and 60 is to compress the stacking structure of the stack with appropriate pressure from the outermost edge of the stacking structure. Accordingly, a rigid end plate is required, and an insulation treatment is needed for the end plates to prevent electrical short circuits. As a result, the end plates 50 and 60 can be made of a light material such as aluminum (Al), and an oxide film or a Teflon coating can be formed on the end plates in order to prevent short circuits.

Illustrated in FIG. 7 is the hole 58 formed on the end plate 50 adjacent to the air electrode. Since the membrane electrode assembly needs air, the air has to be supplied to the air electrode. However, a method of using an artificial air pump increased the volume of a fuel cell and caused noise.

In the case of the flat type stacking structure, however, oxygen in the air can be supplied through the hole 58 by forming the hole 58 on the stacking structure. Since the hole 58 is for supplying oxygen in the air to the air electrode, the hole has to be properly shaped with an appropriate opening ratio. The opening ratio means the relationship between the size of the hole 58 and the size of the air electrode (16 in FIG. 3) of the membrane electrode assembly.

Referring to FIG. 8, there is a difference in maximum power, depending on the shape of the hole 58. A triangular shaped hole has less maximum power than a circular shaped hole or a rectangular shaped hole, and, in the case of the circular shaped hole, the opening ratio securing the maximum power is too small for the water generated from the air electrode to escape. Thus, the rectangular shaped hole is more efficient. Moreover, in the case of the rectangular shaped hole, the maximum power is obtained when the hole occupies 65% of the total area of the electrode, and thus it is efficient to have the opening ratio of 65%, which is the relationship between the size of the hole 58 and the size of the air electrode (16 in FIG. 3) of the membrane electrode assembly.

The aperture (38 in FIG. 4) of the current collector (30 in FIG. 4) adjacent to the air electrode can be formed to correspond to the shape and size of the hole 58.

Referring to FIG. 9, the end plate 60 adjacent to the fuel electrode has the slit 68 formed thereon in the shape of serpentine. The serpentine shape refers to the curved shape of an object or design, as illustrated in FIG. 9. When using the slit 68 in the shape of serpentine, fuel supplied through the fuel supplying hole 64 can be evenly supplied to each of the unit cells (18 in FIG. 2).

Since fuel travels along the slit 68, the aperture (48 in FIG. 6) of the current collector (40 in FIG. 6) adjacent to the fuel electrode can be formed on a corresponding location. The aperture can be a serpentine-shape, corresponding to the slit. However, since it is difficult to affix the current collector (40 in FIG. 6) made of a flexible material, it is possible to form a linearly-long, parallel aperture 48 (in FIG. 6) instead of forming an aperture where the current collector 40 is bent, as illustrated in FIG. 6.

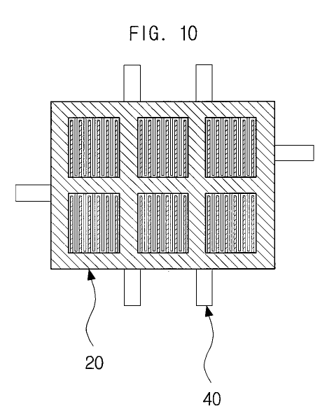

Next, FIG. 10 is a plan view illustrating a gasket according to an aspect of the present invention. Although the gasket 20 is not an essential component in the stack structure, it can be interposed between the membrane electrode assembly 10 and the current collectors 30, and between the membrane electrode assembly 10 and the current collectors 40, as illustrated in FIG. 1, to enhance the efficiency of electricity generation. The gasket 20 is for sealing a gap between the current collector and the membrane electrode assembly such that fuel and air are prevented from leaking, and thus an elastic material, for example, Teflon and perfluoroalkoxy (PFA), which has excellent chemical resistance and elasticity, is a promising material. For a complete sealing structure, as illustrated in FIG. 10, the gasket 20 can be disposed to completely cover a part where the metal pad of the current collector 40 is not formed (referred to FIG. 6), thereby preventing a gap from forming.

Each stacking structure of the stack in accordance with an embodiment of the present invention has been described with reference to FIGS. 2 to 10. Oxygen is supplied to the air electrode by allowing air to flow through the hole 58 of the end plate 50 adjacent to the air electrode. Likewise, hydrogen is supplied to the fuel electrode by allowing fuel to be injected through the fuel supplying hole 64 of the end plate 60 adjacent to the fuel electrode and moved along the slit 68, and thus the membrane electrode assembly 10 generates electrical energy. The electrical energy generated from the membrane electrode assembly 10 can be collected through the current collectors 30 and 40.

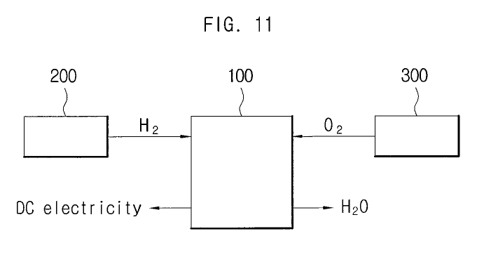

By using the stack described above, a fuel cell power generation system equipped with the stack can be presented. FIG. 11 is a conceptual diagram illustrating a fuel cell power generation system according to another aspect of the present invention. Illustrated in FIG. 11 are the stack 100, a fuel supplying unit 200 and an air supplying unit 300. The fuel supplying unit 200 is for supplying fuel comprising hydrogen to the stack 100, and the air supplying unit 300 is for supplying oxygen to the stack 100.

The fuel supplying unit 200 is for supplying hydrogen as fuel of the fuel cell. Here, hydrogen can be supplied directly by using a hydrogen tank, or the fuel supplying unit 200 itself can be a hydrogen generator to generate and supply hydrogen. The hydrogen generator includes an electrode and an electrolyte aqueous solution, which have different ionization tendency, and generates hydrogen from water by using electrons generated through the oxidization reaction of metal.

The air supplying unit 300 is for supplying oxygen to the fuel cell, and thus an air pump can be used to inject air into the stack. Nevertheless, since oxygen can be supplied without an additional air supply device, i.e., the air pump, in the present embodiment, the air pump can be omitted. The structure of the stack 100 being used in the fuel cell power generation system are substantially the same as that of the stack described above, and thus redundant descriptions will be omitted.

While the spirit of the invention has been described in detail with reference to certain embodiments, the embodiments are for illustrative purposes only and shall not limit the invention. It is to be appreciated that those skilled in the art can change or modify the embodiments without departing from the scope and spirit of the invention. As such, many embodiments other than those set forth above can be found in the appended claims.

What is claimed is:

1. A stack generating electrical energy by reacting hydrogen with oxygen, the hydrogen being supplied as fuel and the oxygen being in the air, the stack comprising:
a membrane electrode assembly (MEA) including an electrolyte membrane and a pair of electrodes coupled to either surface of the electrolyte membrane; and
a pair of current collectors formed on either surface of the membrane electrode assembly,
wherein the current collector comprises:
an insulating polymer film; and
a conductive adhesive layer interposed between the insulating polymer film and the membrane electrode assembly.

2. The stack of claim 1, wherein the conductive adhesive layer comprises:
an adhesive epoxy; and
at least one of metal powder and metal wire.

3. The stack of claim 1, wherein the polymer film is made of a flexible material.

4. The stack of claim 1, further comprising a metal pad interposed between the polymer film and the conductive adhesive layer.

5. The stack of claim 4, wherein the metal pad is made of a material comprising gold (Au).

6. The stack of claim 4, wherein the electrode is constituted by a plurality of unit electrodes, and the metal pad is constituted by a plurality of unit pads in accordance with a shape of the unit electrode.

7. The stack of claim 6, wherein each of the unit pads comprises a terminal formed thereon, the terminal being protruded outward from the current collector.

8. The stack of claim 1, wherein the current collector comprises a plurality of apertures formed thereon.

9. The stack of claim 8, further comprising a pair of end plates formed on the outside of the current collector.

10. The stack of claim 9, wherein the end plate of a side from which the fuel is supplied has a slit formed thereon in a shape of serpentine, and an aperture of the current collector of a side to which the fuel is supplied is shaped to correspond to the slit.

11. The stack of claim 9, wherein the end plate of a side to which the air is supplied has a hole for air flow formed thereon, and an aperture of the current collector of a side to which the air is supplied is shaped to correspond to the hole.

12. The stack of claim 11, wherein the hole is rectangular.

13. The stack of claim 1, further comprising a gasket, the gasket being interposed between the current collector and the membrane electrode assembly and sealing a gap between the current collector and the membrane electrode assembly.

14. A fuel cell power generation system comprising:
a fuel cell stack generating electrical energy by reacting hydrogen with oxygen, the hydrogen being supplied as fuel and the oxygen being in the air;
a fuel supplying unit configured to supply fuel to the fuel cell stack, the fuel containing hydrogen; and
an air supplying unit configured to supply air to the fuel cell stack,
wherein the fuel cell stack comprises:
a membrane electrode assembly (MEA) including an electrolyte membrane and a pair of electrodes coupled to either surface of the electrolyte membrane; and
a pair of current collectors formed on either surface of the membrane electrode assembly, and
wherein the current collector comprises:
an insulating polymer film; and
a conductive adhesive layer interposed between the polymer film and the membrane electrode assembly.

15. The fuel cell power generation system of claim 14, wherein the conductive adhesive layer comprises:
an adhesive epoxy; and
at least one of metal powder and metal wire.

16. The fuel cell power generation system of claim 14, wherein the polymer film is made of a flexible material.

17. The fuel cell power generation system of claim 14, further comprising a metal pad interposed between the polymer film and the conductive adhesive layer.

18. The fuel cell power generation system of claim 17, wherein the metal pad is made of a material comprising gold (Au).

19. The fuel cell power generation system of claim 17, wherein the electrode is constituted by a plurality of unit electrodes, and the metal pad is constituted by a plurality of unit pads in accordance with a shape of the unit electrode.

20. The fuel cell power generation system of claim 19, wherein each of the unit pads comprises a terminal formed thereon, the terminal being protruded outward from the current collector.

21. The fuel cell power generation system of claim 14, wherein the current collector comprises a plurality of apertures formed thereon.

22. The fuel cell power generation system of claim 21, further comprising a pair of end plates formed on the outside of the current collector.

23. The fuel cell power generation system of claim 22, wherein the end plate of a side from which the fuel is supplied has a slit formed thereon in a shape of serpentine, and an aperture of the current collector of a side to which the fuel is supplied is shaped to correspond to the slit.

24. The fuel cell power generation system of claim 22, wherein the end plate of a side to which the air is supplied has a hole for air flow formed thereon, and an aperture of the current collector of a side to which the air is supplied is shaped to correspond to the hole.

25. The fuel cell power generation system of claim 22, wherein the hole is rectangular.

26. The fuel cell power generation system of claim 13, further comprising a gasket being interposed between the current collector and the membrane electrode assembly and sealing a gap between the current collector and the membrane electrode assembly.
